(19) United States
(12) Patent Application Publication
(10) Pub. No.: US 2014/0240437 A1
(43) Pub. Date: Aug. 28, 2014

(54) ADHESIVE LABEL ISSUING APPARATUS AND PRINTER

(71) Applicant: Seiko Instruments Inc., Chiba-shi (JP)

(72) Inventors: Kouji KAWAGUCHI, Chiba-shi (JP); Yoshinori SATO, Chiba-shi (JP)

(73) Assignee: Seiko Instruments Inc., Chiba-shi (JP)

(21) Appl. No.: 14/190,653

(22) Filed: Feb. 26, 2014

(30) Foreign Application Priority Data
Feb. 27, 2013 (JP) 2013-037740

(51) Int. Cl. B65C 9/18; B65C 9/46

(52) U.S. Cl. CPC B65C 9/1803; B65C 9/46
USPC 347/220; 83/401

(57) ABSTRACT

An adhesive label issuing apparatus comprising: a cutter unit; an adhesive force expression unit; and a slack unit, the slack unit including: a downstream paper passing portion arranged between the cutter unit and the adhesive force expression unit along the conveyance direction so as to pass a label paper which has passed the cutter unit therethrough; and an upstream paper passing portion arranged on the upstream side of the downstream paper passing portion along the conveyance direction so as to pass the label paper therethrough, the downstream paper passing portion being arranged so as to be offset with respect to the upstream paper passing portion along a normal direction of an upstream paper passing surface in the upstream paper passing portion and so that a downstream paper passing surface in the downstream paper passing portion and the upstream paper passing surface are in parallel to each other.

### RELATED APPLICATIONS

This application claims priority under 35 U.S.C. §119 to Japanese Patent Application No. 2013-037740 filed on Feb. 27, 2013, the entire content of which is hereby incorporated by reference.

### BACKGROUND OF THE INVENTION

1. Field of the Invention

The present invention relates to an adhesive label issuing apparatus and a printer.

2. Description of the Related Art

In recent years, for example, a release paper-free adhesive label has come into use as an adhesive label used as a POS label for foods, a label for distribution and delivery, a label for medical use, a baggage tag, a display label for bottles and cans, or the like, with a view point of environmental conservation and reducing environmental load. The adhesive label of this type, for example, includes an adhesive label provided with a heat activation adhesive layer, which expresses adhesive force through heating, on the back of a label with a recording surface of thermosensitive coloring type. And then, adhesive force is expressed on the adhesive label by heating the adhesive layer. Additionally, recently, in addition to the label paper provided with the above-mentioned heat activation adhesive agent layer, an adhesive label having, on the back of a label, an adhesive layer made by covering an adhesive agent layer with a coating layer is proposed. In the adhesive label, the above-mentioned adhesive layer is heated to remove part of the coating layer, thereby exposing the adhesive layer there so as to express adhesive force.

A printer for printing and issuing the above-mentioned adhesive label has a printing unit for heating belt-shaped label paper, which is delivered from rolled paper for adhesive label, from the recording surface side so as to perform printing, a cutter unit for passing the label paper after printing therethrough so as to cut the label paper into adhesive labels in desired length, and an adhesive force expression unit for expressing adhesive force by heating the adhesive layer or exposing the adhesive layer by heating the coating layer.

Note that, in the above-mentioned printer, when cutting label paper by the cutter unit, it is cut at a right angle with respect to the length direction of the paper. Therefore it is needed to temporarily stop conveying the label paper to perform cuttings. However, when cutting part of the label paper to be the upstream end of the adhesive label along the conveyance direction by the cutter unit, there is a risk that part to be the downstream end portion of the adhesive label has been conveyed to the adhesive force expression unit. In this case, there is a risk that part to be the downstream end portion of the adhesive label (the part positioned in the adhesive force expression unit) may be discolored due to heat of the adhesive force expression unit or may be stuck to the adhesive force expression unit, thereby causing conveyance failure such as paper jam.

Therefore, in a conventional printer, for example, a slack unit for slacking label paper is provided between the cutter unit and the adhesive force expression unit. As illustrated in FIGS. 6A to 6C, a conventional slack unit 500 has an upstream paper passing portion 501 arranged on the downstream side of the cutter unit (not illustrated) along the conveyance direction so as to pass label paper P therethrough, and a downstream paper passing portion 502 arranged between the upstream paper passing portion 501 and the adhesive force expression unit (not illustrated) so as to pass the label paper P therethrough. Each of these paper passing portions 501, 502 has a pair of rollers 503 to 506 separately and arranged to a position where paper passing surfaces (surface direction when the label paper P passes each paper passing portion 501, 502) are on the same surface respectively (refer to the broken line in FIG. 6B).

Then, in the above-mentioned slack unit 500, for example, rotary driving of the downstream paper passing portion 502 is stopped in the state that the label paper P is stretched between the both paper passing portions 501 and 502, and thereby the label paper P can be slacked between both the paper passing portions 501 and 502 (slack portion 510 in FIG. 6B) as illustrated in FIG. 6B. In this manner, slacking the label paper P on the upstream side of the adhesive force expression unit helps prevent conveyance of the label paper P from stopping in the state that the downstream end portion of the label paper P is positioned in the adhesive force expression unit. Therefore, it is expected that an adhesive label in desired length can be issued while preventing the above-mentioned discoloration and paper jam of the label paper P.

However, in the configuration of the above-mentioned conventional slack unit 500, when slack of the label paper P between both the paper passing portions 501 and 502 becomes large, the upstream side of the slack portion 510 of the label paper P may buckle in the middle (buckling point K), as illustrated in FIG. 6C. Specifically, as the paper passing surfaces of respective paper passing portions 501, 502 are arranged on the same surface, the buckling point K easily occurs in the root portion of the slack portion 510 (the part positioned on respective paper passing surfaces of the slack portion 510) of the label paper P. Additionally, when the buckling point K occurs in the root portion of the slack portion 510, the buckling point K is fed toward the downstream paper passing portion 502 as it is.

As a result, there is a risk that the label paper P advances to the downstream paper passing portion 502 in the state of being folded, thereby causing conveyance failure such as paper jam. Especially, as the label paper P becomes hard at a low temperature (for example, below 5° C.), the slack portion 510 of the label paper P easily buckles. Accordingly, length of an adhesive label issued by a printer needs to be limited to a length that the slack portion 510 of the label paper P does not buckle.

On the other hand, as an interval between respective paper passing portions 501 and 502 becomes larger, the buckling point K occurs less frequently in the slack portion 510 of the label paper P, and therefore the upper limit of length of an issuable adhesive label (hereunder, referred to as issued length) can be larger. However, as an interval between respective paper passing portions 501 and 502 becomes larger, the lower limit of the issued length also becomes larger, and therefore a problem that the issued length lacks flexibility occurs. Additionally, making the interval between respective paper passing portions 501 and 502 larger enlarges the printer as a whole.

In contrast, a configuration of another conventional slack mechanism which has a paper passing direction change means for changing a direction of the upstream paper passing portion between a reference position arranged on the same surface as a paper passing surface of the downstream paper passing portion and an inclination position inclined with respect to the paper passing surface of the downstream paper passing portion has been known. The configuration is considered to change the direction of the upstream paper passing portion to the inclination position by the paper passing direction change means after the downstream end portion of the label paper reaches the downstream paper passing portion so as to change the paper passing direction of the upstream paper passing portion, thereby suppressing the buckling on the upstream side of the slack portion.

However, in the above-mentioned latter configuration of the slack mechanism, a mechanism for changing the paper passing direction of the upstream paper passing portion needs to be provided as the paper passing direction change means, thereby causing problems such as increase in the number of components, enlargement of a printer itself associated with the same, and complication of the configuration.

From these points, in this technical field, an adhesive label issuing apparatus and a printer capable of suppressing buckling of label paper so as to suppress conveyance failure of label paper and improve the flexibility of issued length in addition to downsizing and simplifying the apparatus have been desired.

### SUMMARY OF THE INVENTION

An adhesive label issuing apparatus according to one aspect of the present invention has a cutter unit for passing belt-shaped label paper provided with an adhesive layer on one surface of the belt-shaped label paper therethrough so as to cut the belt-shaped label paper into an adhesive label in a desired length; an adhesive force expression unit arranged on a downstream side of the cutter unit along a conveyance direction of the label paper so as to express adhesive force on the adhesive label by heating the adhesive label from the adhesive layer side; and a slack unit arranged on an upstream side of the adhesive force expression unit along the conveyance direction so as to slack the label paper, the slack unit having a downstream paper passing portion arranged between the cutter unit and the adhesive force expression unit along the conveyance direction so as to pass the label paper which has passed the cutter unit therethrough, and an upstream paper passing portion arranged on the upstream side of the downstream paper passing portion along the conveyance direction so as to pass the label paper therethrough, the downstream paper passing portion being arranged so as to be offset with respect to the upstream paper passing portion along a normal direction of an upstream paper passing surface in the upstream paper passing portion and so that a downstream paper passing surface in the downstream paper passing portion and the upstream paper passing surface are in parallel to each other.

By the configuration, when label paper is fed in order so as to issue an adhesive label, the downstream end portion of the label paper reaches the downstream paper passing portion after being fed from the upstream paper passing portion. At the time, respective paper passing surfaces are arranged in parallel to each other, and therefore the label paper is stretched between the upstream paper passing portion and the downstream paper passing portion smoothly. After that, when delivering the label paper until a cut position of the label paper to be the upstream end portion of an adhesive label reaches a blade edge position of the cutter unit, the label paper is slacked between the upstream paper passing portion and the downstream paper passing portion, thereby making it possible to prevent the downstream end portion of the label paper from advancing to the position of the heat source of the adhesive force expression unit.

Additionally, as the downstream paper passing portion is offset with respect to the upstream paper passing portion along the normal direction of the upstream paper passing surface, the label paper fed from the upstream paper passing portion along the upstream paper passing surface is fed offset with respect to the downstream paper passing surface. In this case, since the label paper is easily fed toward the tip end portion of the slack portion as going toward the downstream side, buckling of the slack portion at the root portion is suppressed, and thereby the slack amount of label paper can be ensured. Accordingly, the slack amount of label paper can be ensured while suppressing conveyance failure of paper jam or the like.

Further, as the slack amount of label paper can be ensured, the interval between respective paper passing portions can be narrow, thereby making it possible to widely deal with adhesive labels of large size to small size. Thereby, the flexibility of issued length of an adhesive label can be improved. Further, an apparatus also can be downsized by making the interval between respective paper passing portions narrow. Furthermore, as the above-mentioned effect is produced by offsetting the paper passing surfaces between respective paper passing portions, it is not needed to provide a mechanism or the like for changing the paper passing direction of the paper passing portion like a conventional case, and thereby an apparatus can be downsized and simplified and also costs can be reduced.

In an adhesive label issuing apparatus according to one aspect of the present invention, the slack unit may have a label guide for guiding the label paper from the upstream paper passing portion toward the downstream paper passing portion. By the configuration, the label paper can be fed toward the downstream paper passing portion smoothly, as the label guide for guiding the label paper from the upstream paper passing portion toward the downstream paper passing portion is provided.

In an adhesive label issuing apparatus according to one aspect of the present invention, the label paper is to be rolled paper in a roll shape and also curled so as to be curved toward the normal direction of the upstream paper passing surface as going from the upstream side to the downstream side along the conveyance direction, and the downstream paper passing portion may be offset in accordance with the curled direction of the label paper of the normal direction of the upstream paper passing surface. By the configuration, label paper can be fed smoothly toward the downstream paper passing portion, as the downstream paper passing portion is offset with respect to the upstream paper passing portion in accordance with the curled direction of label paper.

A printer according to one aspect of the present invention has an adhesive label issuing apparatus; and a printing unit which is arranged on the upstream side of the adhesive force expression unit along a conveyance direction so as to perform printing to the other surface of the label paper. By the configuration, a printer with high reliability can be provided at low cost, as the adhesive force expression unit of the present invention is provided.

In a printer according to one aspect of the present invention, either one of the upstream paper passing portion and the downstream paper passing portion also may serve as the printing unit. By the configuration, the number of components can be reduced and also an apparatus can be further downsized, as the upstream paper passing portion consisted of a conveyance roller or the like does not need to be arranged separately on the upstream side of the downstream paper passing portion.

By an adhesive label issuing apparatus and a printer according to one aspect of the present invention, conveyance failure of label paper can be suppressed and the flexibility of issued length can be improved by suppressing buckling of label paper in addition to downsizing and simplifying an apparatus.

### BRIEF DESCRIPTION OF THE DRAWINGS

FIG. 1 is a schematic diagram illustrating a thermal printer of an embodiment of the present invention;

FIGS. 2A to 2D are enlarged views (side views) of a slack unit;

FIG. 3 is a schematic diagram illustrating a thermal printer in a first modified example;

FIG. 4 is a schematic diagram illustrating a thermal printer in a second modified example;

FIG. 5 is a schematic diagram illustrating a thermal printer in another configuration of the second modified example; and

FIGS. 6A to 6C are explanatory views for explaining a conventional slack unit.

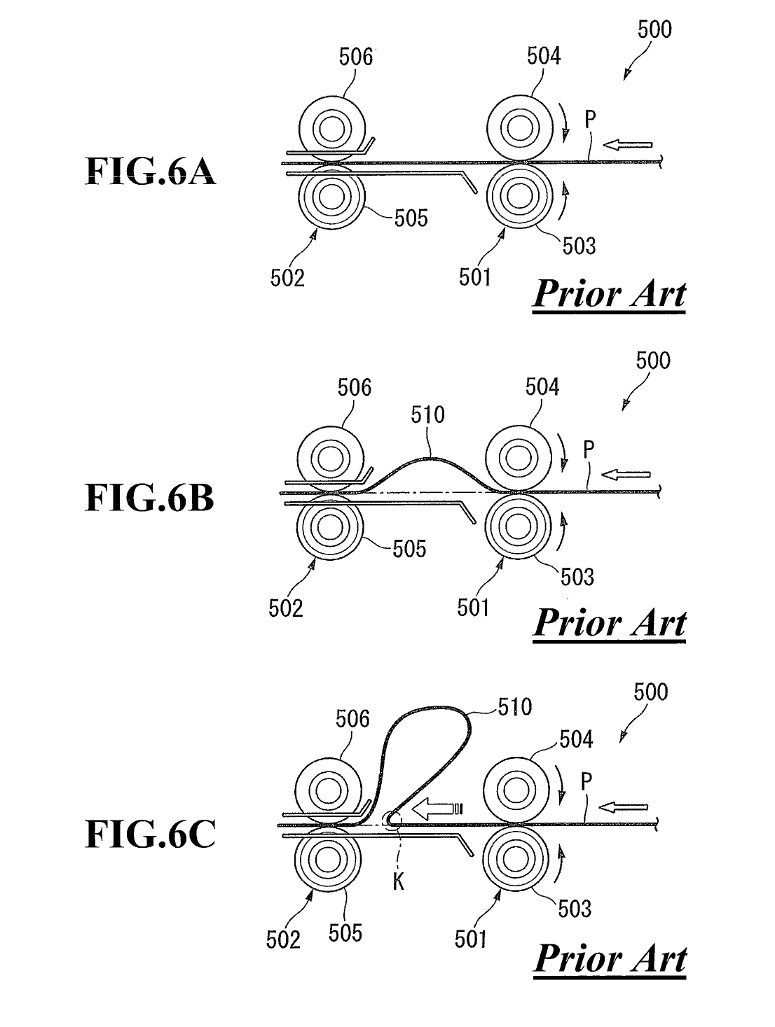

### DETAILED DESCRIPTION OF THE PREFERRED EMBODIMENTS

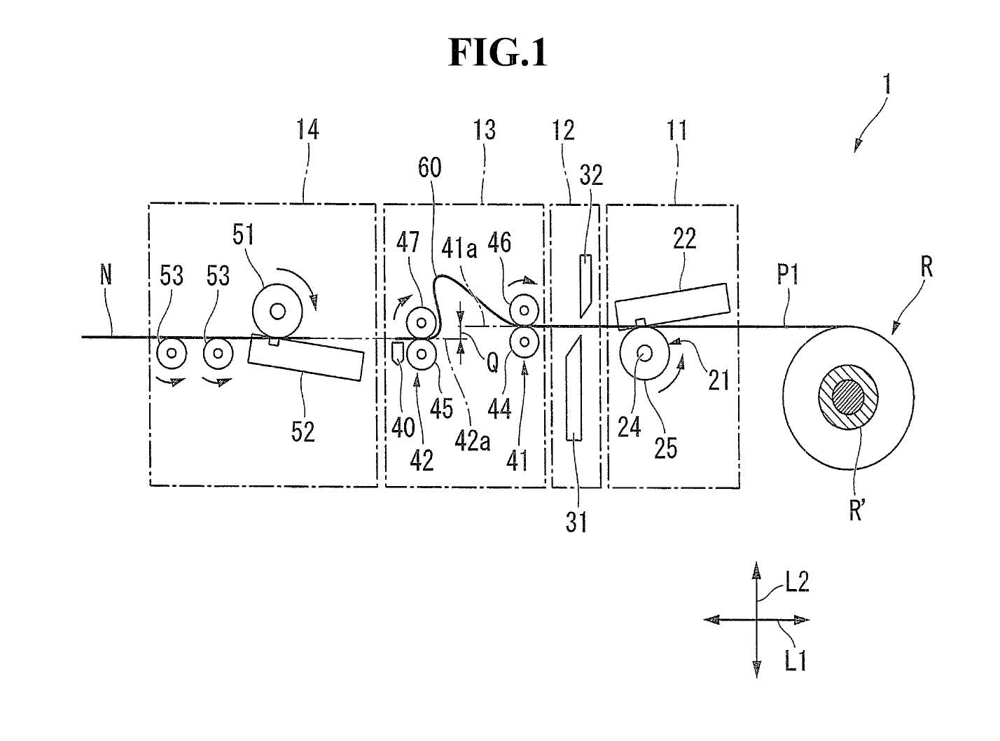

A detailed description will hereunder be given of an embodiment of the present invention with consultation of drawings. Note that, in the following description, a thermal printer provided with an adhesive force expression unit of the present invention will be described. FIG. 1 is a schematic diagram of a thermal printer 1 of the embodiment of the present invention. As illustrated in FIG. 1, the thermal printer 1 of the embodiment (hereunder, referred to as printer 1) is an apparatus for performing printing to belt-shaped label paper P1 delivered from rolled paper R and then cutting the label paper P1 into a predetermined length to be an adhesive label N to express adhesive force on the adhesive label N and issue a label. Note that, in a side view of a printer 1 illustrated in FIG. 1 of the embodiment, the conveyance direction of the label paper P1 will be explained as L1, the side of a rolled paper R along the conveyance direction L1 will be explained as the upstream side, and the tip end side of the conveyance direction L1 will be explained as the downstream side. Also note that, in the side view of the printer 1 illustrated in FIG. 1, the thickness direction of the label paper P1 conveyed along the conveyance direction L1 will be explained as the vertical direction L2.

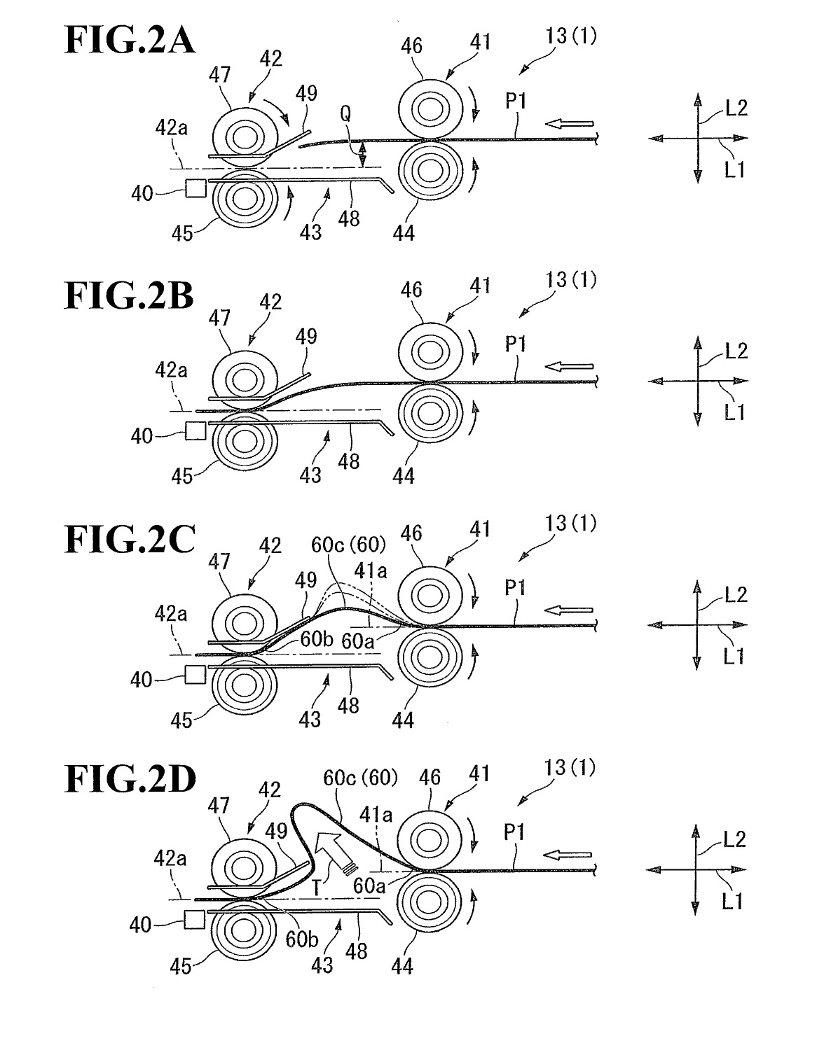

Firstly, the rolled paper R is configured by winding the above-mentioned label paper P1 around a cylindrical core material R′ and rotatably stored in a rolled paper storage portion, not illustrated, which is arranged to the upstream end of the printer 1. The label paper P1 (adhesive label N) of the embodiment is provided with an adhesive layer made of an adhesive agent layer and a coating layer which coats the surface of the adhesive agent layer on the back (one surface) of a thermosensitive coloring surface (the other surface) of thermal paper and expresses adhesive force on the adhesive layer thereof by applying heat to remove part of the coating layer, thereby exposing the adhesive agent layer. The label paper P1 of the embodiment is wound in the state that the thermosensitive coloring surface is oriented outwardly in the radial direction of the core material R′ and the adhesive layer is oriented inwardly in the radial direction of the core material R′. Note that the label paper P1 (adhesive label N) may be provided with an adhesive layer made of a heat activation adhesive agent on the back (one surface) of the thermosensitive coloring surface (the other surface) of the thermal paper. Also note that the label paper P1 delivered from the rolled paper R has a curl with a predetermined curvature following the winding direction of the rolled paper R. Specifically, the label paper P1 of the embodiment has a curl of being curved toward the adhesive layer side (lower side in the figure) as going toward the downstream side of the conveyance direction L1 (refer to FIG. 2A).

The printer 1 of the embodiment has a printing unit 11 for heating the thermosensitive coloring surface of the label paper P1 delivered from the above-mentioned rolled paper R so as to perform printing on the label paper P1, a cutter unit 12 for passing the label paper P1 therethrough and cutting the label paper P1 into a predetermined length, a slack unit 13 for slacking the label paper P1 which has passed the cutter unit 12, and an adhesive force expression unit 14 for heating the adhesive layer of the adhesive label N which has been cut in the cutter unit 12 so as to express adhesive force on the adhesive label N. Note that the adhesive label issuing apparatus is configured by the above-mentioned cutter unit 12, slack unit 13, and adhesive force expression unit 14.

The printing unit 11 has a so-called thermal print mechanism in which a printing platen roller 21 and a printing thermal head 22 are arranged opposingly each other along the vertical direction L2, being arranged on the downstream side of the conveyance direction L1 with respect to the rolled paper storage portion, not illustrated. The printing thermal head 22 is a line head with a number of heating elements (not illustrated) along the width direction of the label paper P1 and arranged on the thermosensitive coloring surface side (upper side) of the label paper P1. Additionally, the printing thermal head 22 is pressed to the printing platen roller 21 side (lower side) by a coil spring or the like, not illustrated, so as to be brought into pressure contact with the outer peripheral surface of the printing platen roller 21.

The printing platen roller 21 externally mounts a roller body 25 consisted of rubber or the like on a shaft 24 which extends along the width direction of the label paper P1, being arranged on the adhesive layer side (lower side) of the label paper P1. The printing platen roller 21 is configured so as to rotate by being driven by a drive source, such as a motor or the like, not illustrated.

In the printing unit 11, the label paper P1 is conveyed by being delivered from the rolled paper R by turning the printing platen roller 21 in the state that the label paper P1 is clamped between the printing platen roller 21 and the printing thermal head 22.

The cutter unit 12 has a fixed blade 31 and a movable blade 32, being arranged on the downstream side of the conveyance direction L1 with respect to the printing unit 11. The fixed blade 31 and the movable blade 32 are arranged so as to be opposed to each other in the vertical direction with the label paper P1 therebetween. The fixed blade 31 is arranged on the adhesive layer side (lower side) of the label paper P1, and the movable blade 32 is arranged on the thermosensitive coloring surface side (upper side) of the label paper P1. The movable blade 32 is slidable and capable of approaching and separating from the fixed blade 31, and also capable of cutting by vertically clamping the label paper P1 between the fixed blade 31 and the movable blade 32. Note that the fixed blade 31 and the movable blade 32 may be arranged so as to interchange the positions thereof in the vertical direction.

FIGS. 2A to 2D are enlarged views (side views) of a slack unit 13. As illustrated in FIG. 1 and FIG. 2A, the slack unit 13 is for slacking the label paper P1 which has passed the cutter unit 12 on the upstream side with respect to an adhesive force expression unit 14, having an upstream paper passing portion 41, a downstream paper passing portion 42, and a label guide 43 for guiding the label paper P1 between the upstream paper passing portion 41 and the downstream paper passing portion 42. The upstream paper passing portion 41 and the downstream paper passing portion 42 have a pair of conveyance rollers, namely drive rollers 44, 45 and driven rollers 46, 47 separately, being arranged with a predetermined interval along the conveyance direction L1.

Each drive roller 44, 45 is made by mounting an exterior body composed of rubber or the like on a shaft extending along the width direction of the label paper P1, being arranged on the adhesive layer side (lower side) of the label paper P1. Each drive roller 44, 45 is connected to a drive source, such as a motor or the like, not illustrated, via a gear transmission mechanism, not illustrated, being configured so as to rotate by transmitting power of the drive source to each drive roller 44, 45 via the gear transmission mechanism.

Each driven roller 46, 47 is made by mounting an exterior body composed of rubber or the like on a shaft extending in parallel with each drive roller 44, 45, being arranged on the thermosensitive coloring surface side (upper side) of the label paper P1. Each driven roller 46, 47 is brought into pressure contact with the outer peripheral surface of each drive roller 44, 45 by a pressing means or the like, not illustrated. Note that the drive rollers 44, 45 and the driven rollers 46, 47 may be arranged so as to interchange the positions thereof in the vertical direction.

Then, in each paper passing portion 41, 42, the drive rollers 44, 45 are rotated by driving the drive source so that the driven rollers 46, 47 are rotated in the opposite direction of the rotation direction of the drive rollers 44, 45 according to the rotations of the drive rollers 44, 45. At this time, the label paper P1 advances between the drive rollers 44, 45 and the driven rollers 46, 47 so that the label paper P is fed by the drive rollers 44, 45 and the driven rollers 46, 47 which rotate so as to be conveyed.

Here, the downstream paper passing portion 42 is offset with respect to the upstream paper passing portion 41 along the normal direction (vertical direction L2) of the upstream paper passing surface 41a in the upstream paper passing portion 41 (refer to FIG. 1), and also the downstream paper passing surface 42a in the downstream paper passing portion 42 and the upstream paper passing surface 41a are arranged so as to be in parallel with each other. Each paper passing surface 41a, 42a in the embodiment is the surface direction of the label paper P1 when the label paper P1 passes each paper passing portion 41, 42. Specifically, it is a surface orthogonal to a virtual straight line which connects the rotation center of each drive roller 44, 45 (shaft) and the rotation center of each driven roller 46, 47 (shaft) in each paper passing portion 41, 42. Note that, in the illustrated example, the upstream paper passing surface 41a is arranged on the same surface as the paper passing surface of the printing unit 11 and the cutter unit 12, and the downstream paper passing surface 42a is arranged on the same surface as the paper passing surface of the adhesive force expression unit 14.

Further, the downstream paper passing portion 42 of the embodiment is offset by a predetermined distance (offset amount Q) in the same direction as the curl of the label paper P1 (downward) of the vertical direction. Note that the offset amount Q of the downstream paper passing portion 42 is preferably set smaller than the diameter of each roller 44 to 47 (for example, around 15 mm), and it is set to around 5 mm to 10 mm, for example, in the illustrated example.

As illustrated in FIGS. 2A to 2D, the label guide 43 has a first guide 48 and a second guide 49 which are opposed with each other in the vertical direction with the downstream paper passing surface 42a therebetween. The label guide 43 is used for guiding the label paper P1, which is passed through the upstream paper passing portion 41, toward the downstream paper passing portion 42, and the height of the vertical direction L2 becomes narrow generally as going from the upstream side toward the downstream side.

Specifically, the first guide 48 extends on the drive roller 45 side (lower side) with respect to the downstream paper passing surface 42a along the downstream paper passing surface 42a, and its upstream end portion approaches the drive roller 44 of the upstream paper passing portion 41. The second guide 49 is arranged on the driven roller 47 side (upper side) with respect to the downstream paper passing surface 42a. In the second guide 49, the downstream portion thereof extends along the downstream paper passing surface 42a, and also the upstream portion thereof is inclined upward as going from the downstream side toward the upstream side. Note that, in the illustrated example, the upstream end portion of the second guide 49 is arranged in the position opposed to the upstream paper passing surface 41a.

Further, the slack unit 13 is provided with an optical sensor 40 for detecting that the downstream end portion of the label paper P1 reaches the downstream paper passing portion 42. The optical sensor 40 is a reflection type sensor or a transmission type sensor which is arranged on the downstream side of the conveyance direction L1 with respect to the downstream paper passing portion 42. Note that the optical sensor 40 may be arranged on the upstream side of the downstream paper passing portion 42. Further, the detection means for detecting that the downstream end portion of the label paper P1 reaches the downstream paper passing portion 42 may be other than the above-mentioned optical sensor 40, and it can be detected by using a micro switch, or calculating the paper feed amount of the label paper P1, for example.

As illustrated in FIG. 1, the adhesive force expression unit 14 has an adhesive force expression platen roller 51 and an adhesive force expression thermal head 52 arranged opposingly each other along the vertical direction L2, and is arranged on the downstream side of the conveyance direction L1 of the slack unit 13. Note that, as the adhesive force expression unit 14 is configured in nearly the same way except for that the adhesive force expression platen roller 51 and the adhesive force expression thermal head 52 are arranged so as to be interchanged in the vertical direction with the above-mentioned platen roller 21 and the printing thermal head 22 of the printing unit 11, detailed description will be omitted. Namely, the adhesive force expression platen roller 51 is arranged on the thermosensitive coloring surface side (upper side) and the adhesive force expression thermal head 52 is arranged on the adhesive layer side (lower side) with respect to the label paper P1.

Additionally, an ejection roller 53 for conveying an adhesive label N expressing adhesive force thereon to an ejection port, not illustrated, is disposed on the downstream side of the conveyance direction L1 with respect to the adhesive force expression unit 14.

Note that, all of the above-mentioned printing platen roller 21, two drive rollers 44, 45 of the slack unit 13, adhesive force expression platen roller 51, and ejection roller 53 except for the drive roller 45 of the downstream paper passing portion 42 can be synchronized with each other using a common motor or the like as a drive source so as to be driven. However, each of the above-mentioned rollers 21, 44, 45, 51, and 53 may be configured to have respective drive source so as to be driven independently.

Next, an operation method of the above-mentioned printer 1 will be described. Firstly, as illustrated in FIG. 1, operation preparation of the printer 1 is performed. Specifically, a rolled paper R is set in a roll storage portion, not illustrated, and the tip end portion of the label paper P1 thereof is inserted between the printing platen roller 21 and the printing thermal head 22 of the printing unit 11.

Next, an external input apparatus, not illustrated, is connected to the printer 1, and label information together with a label issue order is output from the external input apparatus to the printer 1. The label information includes length of the adhesive label N, printing data, and adhesive force expression region or the like, for example. Note that, when the printer 1 itself is provided with an input portion, the printer 1 does not need to be connected to the external input apparatus, and a label issue order and label information can be input from the input portion of the printer 1.

In the printer 1, when receiving a label issue order and label information, a drive source such as a motor or the like, not illustrated, is driven, then power of the drive source is transmitted to the printing platen roller 21 via a gear transmission mechanism, not illustrated, so as to rotate the printing platen roller 21 (refer to the arrow in the figure). Thereby, the label paper P1 clamped between the printing platen roller 21 and the printing thermal head 22 is passed to the downstream side (cutter unit 12 side) along the conveyance direction L1, and then the label paper P1 is fed while the label paper P1 being delivered from the rolled paper R. At this time, the printing thermal head 22 is driven, and thereby printing is performed according to the above-mentioned label information to the thermosensitive coloring surface of the label paper P1 passing between the printing platen roller 21 and the printing thermal head 22. As a result, bar codes and letters or the like are printed in order on the thermosensitive coloring surface of the label paper P1 passing the printing unit 11.

As illustrated in FIG. 1, FIG. 2A, the label paper P1 having passed the printing unit 11 reaches the upstream paper passing portion 41 of the slack unit 13 after passing between the fixed blade 31 and the movable blade 32 of the cutter unit 12. At the time, as the drive roller 44 and the driven roller 46 are rotated respectively (refer to the arrow in the figure) following the drive of the drive roller 44 in the upstream paper passing portion 41, the label paper P1 is passed between the drive roller 44 and the driven roller 46 and fed toward the downstream side.

The label paper P1 having passed the upstream paper passing portion 41 is guided toward the downstream paper passing portion 42 by the label guide 43. Specifically, the label paper P1 is guided downward following the inner surface of the second guide 49 by means of the downstream end portion thereof hitting against the second guide 49 of the label guide 43 from the upstream side. Thereby, the downstream end portion of the label paper P1 reaches the downstream paper passing portion 42. At the time, as the drive roller 45 and the driven roller 47 are rotated respectively following the drive of the drive roller 45 of the downstream paper passing portion 42 (refer to the arrow in the figure), the label paper P1 is passed between the drive roller 44 and the driven roller 46 and fed toward the downstream side.

Note that, in the embodiment, respective paper passing surfaces 41a, 42a of respective paper passing portions 41, 42 are arranged in parallel with each other, and the downstream paper passing portion 42 is offset with respect to the upstream paper passing portion 41 in the same direction of the curl of the label paper P1. Therefore, the label paper P1 is stretched between the upstream paper passing portion 41 and the downstream paper passing portion 42 smoothly.

Next, in the slack unit 13, the label paper P1 is bent. Specifically, as illustrated in FIG. 2B, the rotation of the drive roller 45 of the downstream paper passing portion 42 between the paper passing portions 41, 42 is stopped upon first detecting the downstream end portion of the label paper P1 by the optical sensor 40. Thereby, conveyance of the label paper P1 to the downstream side with respect to the downstream paper passing portion 42 is stopped. At this time, the label paper P1 is stretched between respective paper passing portions 41, 42 in the state of being curved downward as going from the upstream paper passing portion 41 to the downstream paper passing portion 42.

On the other hand, as illustrated in FIG. 2C, between the upstream paper passing portion 41 and the downstream paper passing portion 42, the label paper P1 slacks in the angle shape swelling upward (the thermosensitive coloring surface side) between the paper passing portions 41, 42 (slack portion 60 in the figure) by feeding the label paper P1 in order from the upstream paper passing portion 41. Specifically, the slack portion 60 has an upstream root portion 60a and a downstream root portion 60b each positioned on each paper passing surface 41a, 42a, and a top portion 60c positioned between the root portions 60a, 60b. Note that the slack amount of the slack portion 60 (height of the slack portion 60 along the vertical direction L2) becomes larger in accordance with feeding of the label paper P1.

Then, as mentioned above, as each paper passing surface 41a, 42a (the upstream root portion 60a and the downstream root portion 60b) of each paper passing portion 41, 42 is offset in the vertical direction L2, the label paper P1 fed from the upstream paper passing portion 41 along the upstream paper passing surface 41a is fed offset with respect to the downstream paper passing surface 42a. In this case, the label paper P1 fed in the state of being stretched between the paper passing portions 41, 42 becomes difficult to go to the downstream paper passing portion 42 (the downstream root portion 60b) and becomes easy to be fed toward the top portion 60c of the slack portion 60 as going toward the downstream side (the arrow T in FIG. 2D). As a result, the slack portion 60 grows upward positively. Also, as illustrated in FIG. 2D, when the slack amount of the label paper P1 becomes larger, the slack portion 60 becomes in the inclined state toward the downstream side of the conveyance direction L1, and therefore a buckling point does not occur in the root portions 60a, 60b of the slack portion 60.

After that, when the cut position of the label paper P1 (the position to be the upstream end of the adhesive label N) advances up to the blade edge position of the cutter unit 12, the label paper P1 positioned in the blade edge position is cut. Specifically, when the cut position of the label paper P1 is moved up to the blade edge position of the fixed blade 31, the rotation of the drive roller 44 of the upstream paper passing portion 41 is stopped so as to temporarily stop the conveyance of the label paper P1.

In this state, the cutter unit 12 is actuated so as to move the movable blade 32 to the fixed blade 31 side, and thereby the label paper P1 is cut with the fixed blade 31 and the movable blade 32. Thereby, the adhesive label N in a predetermined length is cut off from the label paper P1. After that, a drive source, not illustrated, is redriven so as to rotate each drive roller 44, 45 of each paper passing portion 41, 42 respectively, thereby conveying the adhesive label N toward the adhesive force expression unit 14 side.

Note that means for detecting that the cut position of the label paper P1 is moved up to the blade edge position of the cutter unit 12 include a means for detecting the cut position by an optical sensor or a micro switch, not illustrated, or a means for detecting it on the basis of a label length dimension by label information and a calculation value of the paper feed amount of the label paper P1.

The adhesive label N fed from the downstream paper passing portion 42 is fed toward the downstream side by the rotation of the adhesive force expression platen roller 51 when advancing between the adhesive force expression platen roller 51 and the adhesive force expression thermal head 52 in the adhesive force expression unit 14. At this time, the adhesive force expression thermal head 52 is driven, and thereby the adhesive layer of the adhesive label N passing the adhesive force expression platen roller 51 and the adhesive force expression thermal head 52 is heated. Thereby, adhesive force is expressed on the adhesive label N. Then, the adhesive label N having been fed from between the adhesive force expression platen roller 51 and the adhesive force expression thermal head 52 is conveyed to the ejection port side, not illustrated, by the ejection roller 53 so as to be ejected from the ejection port.

The embodiment has a configuration that the downstream paper passing portion 42 is offset with respect to the upstream paper passing portion 41 along the normal direction of the upstream paper passing surface 41a, and also the downstream paper passing surface 42a and the upstream paper passing surface 41 a are in parallel with each other. In the configuration, the label paper P1 fed from the upstream paper passing portion 41 along the upstream paper passing surface 41a in the state of being stretched between the paper passing portions 41, 42 is fed offset with respect to the downstream paper passing surface 42a. In this case, the label paper P1 is easily fed toward the top portion 60c of the slack portion 60 as going toward the downstream side, and therefore buckling of the slack portion 60 at the root portions 60a, 60b is suppressed, and thereby the slack amount of the label paper P1 can be ensured. As a result, the slack amount of the label paper P1 can be ensured while suppressing conveyance failure such as paper jam or the like.

Further, as the slack amount of the label paper P1 can be ensured, the interval between the paper passing portions 41, 42 can be narrow, thereby being capable of widely responding to the adhesive labels N of from large size to small size. Thereby, the flexibility of an issued length of the adhesive label N can be improved. Further, the printer 1 can be downsized by making the interval between the paper passing portions 41, 42. Furthermore, in the embodiment, the paper passing surfaces 41a, 42a are offset between the paper passing portions 41, 42, and thereby the above-mentioned operational effect is performed. Therefore, a mechanism or the like for changing the paper passing direction of the paper passing portion as in a conventional case does not need to be provided, and cost can be low while the apparatus is downsized and simplified.

Additionally, in the embodiment, as the label guide 43 for guiding the label paper P1 from the upstream paper passing portion 41 toward the downstream paper passing portion 42 is provided, the label paper P1 can be fed toward the downstream paper passing portion 42 smoothly.

Additionally, as the printer 1 of the embodiment is provided with the above-mentioned slack unit 13, the printer 1 with high credibility can be provided at low cost.

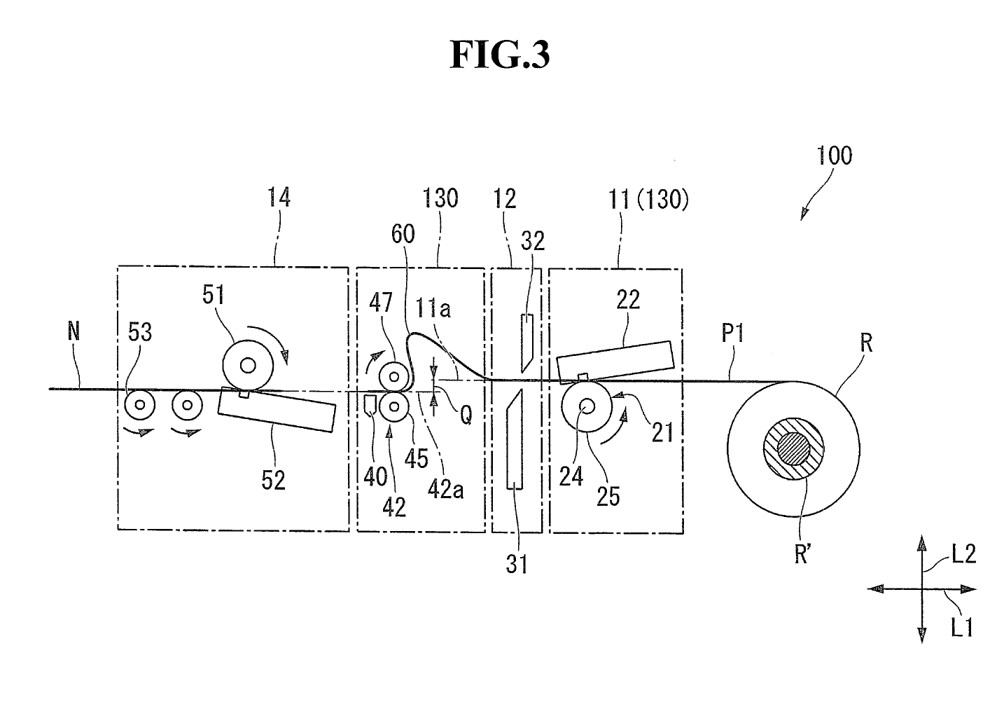

Next, a first modified example of the embodiment will be described. FIG. 3 is a schematic diagram of a printer 100 illustrating the first modified example. Note that, in the following description, the same configuration as the above-mentioned embodiment is designated by the same sign so as to omit the description properly. The modified example is different from the above-mentioned embodiment in that the upstream paper passing portion also serves as the printing unit 11. In the printer 100 illustrated in FIG. 3, the downstream paper passing portion 42 is arranged so that the downstream paper passing surface 42a is offset along the vertical direction L2 with respect to the paper passing surface 11a of the printing unit 11 and the respective paper passing surfaces 42a, 11a are in parallel with each other. Note that the paper passing surface 11a of the printing unit 11 is a surface direction of the label paper P1 when the label paper P1 is passed between the printing platen roller 21 and the printing thermal head 22.

As stated above, in the modified example, the upstream paper passing portion also serves as the printing unit 11 so as to configure the slack unit 130 by the printing unit 11 and the downstream paper passing portion 42. By the configuration, the same operational effect as the above-mentioned embodiment is performed, and also an additional upstream paper passing portion such as a roller does not need to be arranged on the upstream side of the downstream paper passing portion 42. Therefore, the number of components is reduced and also the apparatus can be further smaller. Note that, although the configuration that the upstream paper passing portion also serves as the printing unit 11 is described in the modified example, the configuration that the downstream paper passing portion also serves as the printing unit 11 may be employed without being restricted to the above-mentioned configuration.

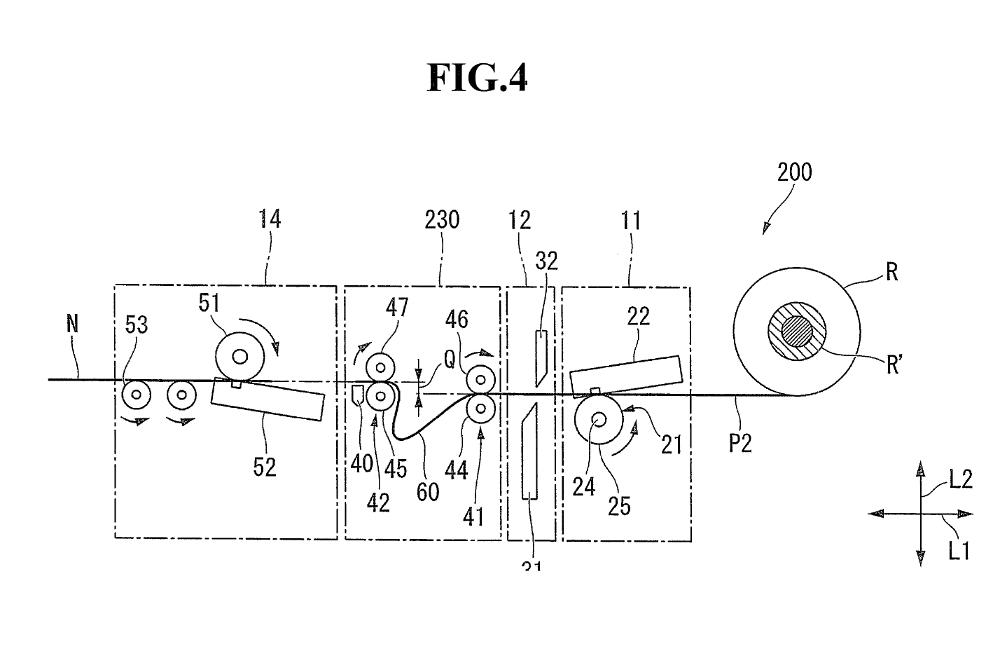

Next, a second modified example of the embodiment will be described. FIG. 4 is a schematic diagram of a printer 200 illustrating the second modified example. Note that, in the following description, the same configuration as the above-mentioned embodiment is designated by the same sign so as to omit the description properly. The printer 200 illustrated in FIG. 4 is different in that each paper passing portion 41, 42 of the slack unit 230 is offset in the direction opposite to each paper passing portion 41, 42 of the slack unit 13 (refer to FIG. 1) of the above-mentioned embodiment. Specifically, the downstream paper passing portion 42 is offset upward with respect to the upstream paper passing portion 41.

Note that the label paper P2 wound in the state that the thermosensitive coloring surface is oriented inside of the radial direction of the core material R′ and the adhesive layer is oriented outside of the radial direction of the core material R′ has a curl curved toward the thermosensitive coloring surface side (upward in the figure). On the other hand, as the slack unit 230 of the modified example is offset in the same direction as the direction of curl of such label paper P2, the label paper P2 can be conveyed smoothly from the upstream paper passing portion 41 toward the downstream paper passing portion 42 as in the above-mentioned embodiment.

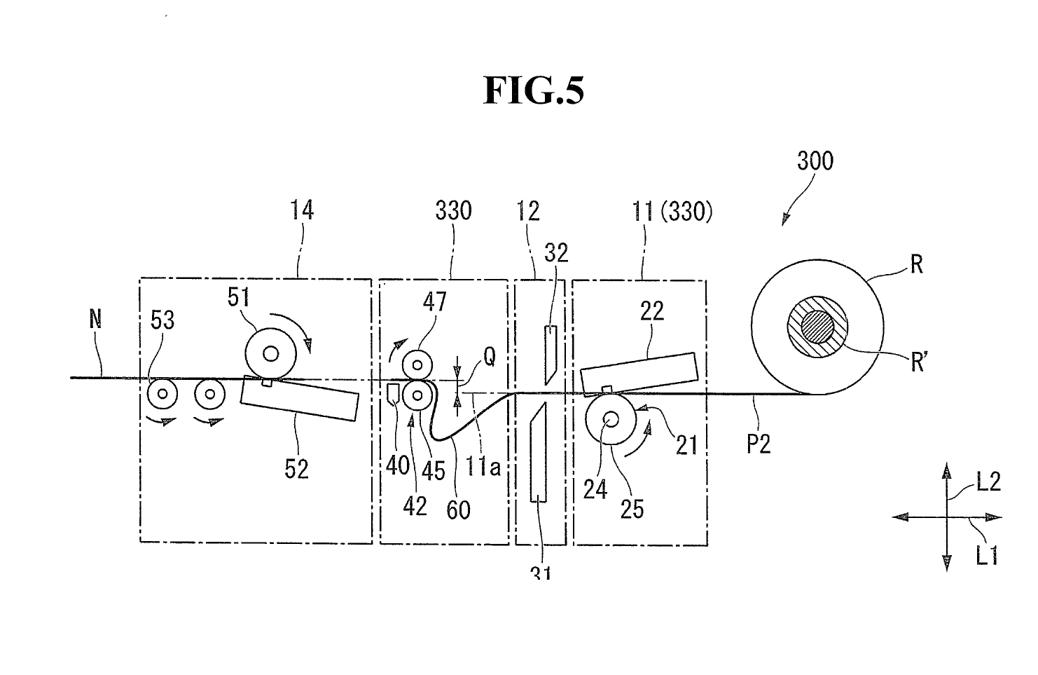

Further, in the modified example as well, the upstream paper passing portion of the slack unit 330 of the printer 300 illustrated in the FIG. 5 may have a configuration that the upstream paper passing portion serves as the printing unit 11 as in the above-mentioned first modified example.

Note that the technical scope of the present invention is not restricted to the above-mentioned embodiment, and various alteration can be added without departing from the spirit of the present invention. For example, although the case that the adhesive label issuing apparatus is applied to the thermal printer 1 is described in the above-mentioned embodiment, it is not restricted to the configuration. Further, the printing unit 11 may be arranged on the upstream side of the conveyance direction L1 with respect to the adhesive force expression unit 14, and it may be arranged between the cutter unit 12 and the adhesive force expression unit 14, for example.

Additionally, the distance between the paper passing portions 41, 42 and the offset amount Q or the like can be changed properly in design in accordance with the desired slack amount H and a type of used label paper P1, P2 or the like. Further, as a cutter unit, a so-called rotary cutter provided with a movable blade where a spiral-shaped blade is formed on the outer peripheral surface of a rotatable support portion and a fixed blade for clamping the label paper between the movable blade and itself so as to cut the same may be employed. By the rotary cutter, it becomes possible to rotate the movable blade so as to cut the label paper P1, P2 while conveying them. In this case, cutting can be performed in the state that the downstream paper passing portion 42 is stopped and the upstream paper passing portion 41 is driven, namely while slacking the label paper P1, P2 between the paper passing portions 41, 42. Therefore, the issue cycle of the adhesive label N can be shortened.

Additionally, in the above-mentioned embodiment, the configuration that the drive of the downstream paper passing portion 42 is stopped at the time when the downstream end portion of the label paper P1, P2 reaches the downstream paper passing portion 42 is described. However, it is not restricted to the configuration. For example, it may be a configuration that rotation speed of the drive roller 45 of the downstream paper passing portion 42 is slowed down compared to the rotation speed of the drive roller 44 of the upstream paper passing portion 41, and thereby the paper feed amount per unit time by the downstream paper passing portion 42 becomes less than the paper feed amount per unit time by the upstream paper passing portion 41.

Additionally, although the configuration that the paper passing portions 41, 42 are offset in accordance with the direction of the curl of the label paper P1, P2 is described in the above-mentioned embodiment, it may be offset regardless of the curl.

What is claimed is:

1. An adhesive label issuing apparatus comprising:
a cutter unit for passing belt-shaped label paper provided with an adhesive layer on one surface of the belt-shaped label paper therethrough so as to cut the belt-shaped label paper into an adhesive label in a desired length;
an adhesive force expression unit arranged on a downstream side of the cutter unit along a conveyance direction of the label paper so as to express adhesive force on the adhesive label by heating the adhesive label from the adhesive layer side; and
a slack unit arranged on an upstream side of the adhesive force expression unit along the conveyance direction so as to slack the label paper,
wherein the slack unit includes:
a downstream paper passing portion arranged between the cutter unit and the adhesive force expression unit along the conveyance direction so as to pass the label paper which has passed the cutter unit therethrough; and
an upstream paper passing portion arranged on the upstream side of the downstream paper passing portion along the conveyance direction so as to pass the label paper therethrough,
and wherein the downstream paper passing portion is arranged so as to be offset with respect to the upstream paper passing portion along a normal direction of an upstream paper passing surface in the upstream paper passing portion and so that a downstream paper passing surface in the downstream paper passing portion and the upstream paper passing surface are in parallel to each other.

2. An adhesive label issuing apparatus according to claim 1, wherein
the slack unit includes a label guide for guiding the label paper from the upstream paper passing portion toward the downstream paper passing portion.

3. An adhesive label issuing apparatus according to claim 1, wherein
the label paper is to be rolled paper in a roll shape and also curled so as to be curved toward the normal direction of the upstream paper passing surface as going from the upstream side to the downstream side along the conveyance direction, and
the downstream paper passing portion is offset in accordance with the curled direction of the label paper of the normal direction of the upstream paper passing surface.

4. An adhesive label issuing apparatus according to claim 2, wherein
the label paper is to be rolled paper in a roll shape and also curled so as to be curved toward the normal direction of the upstream paper passing surface as going from the upstream side to the downstream side along the conveyance direction, and
the downstream paper passing portion is offset in accordance with the curled direction of the label paper of the normal direction of the upstream paper passing surface.

5. A printer comprising:
the adhesive label issuing apparatus according to claim 1; and
a printing unit which is arranged on the upstream side of the adhesive force expression unit along a conveyance direction so as to perform printing to the other surface of the label paper.

6. A printer according to claim 5, wherein
either one of the upstream paper passing portion and the downstream paper passing portion serves as the printing unit.

7. A printer comprising:
the adhesive label issuing apparatus according to claim 4; and
a printing unit which is arranged on the upstream side of the adhesive force expression unit along a conveyance direction so as to perform printing to the other surface of the label paper.

8. A printer according to claim 7, wherein
either one of the upstream paper passing portion and the downstream paper passing portion serves as the printing unit.
